(19) United States
(12) Patent Application Publication
(10) Pub. No.: US 2010/0071513 A1
(43) Pub. Date: Mar. 25, 2010

(54) DEVICE FOR REMOVING A STOPPER OF A PHOTORESIST BOTTLE

(75) Inventor: MING CHOU WANG, TAIPEI COUNTY 238 (TW)

Correspondence Address: ROSENBERG, KLEIN & LEE, 3458 ELLICOTT CENTER DRIVE-SUITE 101, ELLICOTT CITY, MD, 21043, US

(73) Assignee: INOTERA MEMORIES, INC., TAOYUAN COUNTY 333 (TW)

(21) Appl. No.: 12/276,816

(22) Filed: Nov. 24, 2008

(30) Foreign Application Priority Data
Sep. 24, 2008 (TW) 97136605

(51) Int. Cl. B67B 7/62

(52) U.S. Cl. 81/3.37

(57) ABSTRACT

A device for removing a stopper of a photoresist bottle is used for removing a stopper disposed on a photoresist bottle. The stopper includes a stopper element and at least two push buttons. The device includes a casing covering the stopper element and at least two levering units corresponding to the two push buttons. Each levering unit includes a lever pivotally disposed on the casing and a lifting element of which one end is pivotingly disposed on the lever and the other end abuts against a bottom of the stopper element. Under action of the moment, the stopper can be removed from a bottle mouth of the photoresist bottle. So users can remove the stopper with reduced effort and increased efficiency based on the present invention.

### BACKGROUND OF THE INVENTION

1. Field of the Invention

The present invention relates to a device for removing a stopper of a photoresist bottle, and more particularly to a device for removing a stopper disposed on a photoresist bottle with reduced effort and increased efficiency.

2. Description of Related Art

With the development of semiconductor process technology, semiconductor chips have more functions, so signal transmission quantity of semiconductor chips is increasing and pins of the semiconductor chips become more and more. Packaging technology must be improved with the development of semiconductor process technology in order that information products become lighter and smaller, for example, notebook computers, mobile communication products, or digital cameras, etc.

On the other hand, in a semiconductor process, each step must be strictly controlled and projected and different materials and equipment must be used to achieve a high yield rate. For example, various acid and alkali chemical liquid is widely used in etching steps and photoresist is a necessary chemical in lithography processes. Recently, with the development of semiconductor process technology, photoresist is more and more important and more and more varieties of photoresist occur, for example, thick film photoresist, photoresist with high photosensitivity and so on. Manufacturers have a high demand on the quality of photoresist, in other words, manufacturers must grasp the quality and other parameters of photoresist at any time, thereby avoiding that the quality of photoresist is poor or the features and the parameters of photoresist do not correspond to specifications resulting in the decrease of yield rate.

As shown in FIG. 1, for determining the quality of photoresist in a photoresist bottle 30′, a stopper 20′ is generally mounted on the photoresist bottle 30′. A stopper element 201′ of the stopper 20′ is clamped in a bottle mouth of the photoresist bottle 30′ and a pipe thereof extends into the photoresist bottle 30′, so that a sensing module disposed in the stopper 20′ can sense and analyze the photoresist and users can find out various parameters of the photoresist. However, when users want to detach the stopper 20′ from the photoresist bottle 30′, they must press push buttons 2011′ on the sides of the stopper element 201′ and exert an upward force on the stopper 20′ to lift the stopper 20′ simultaneously. These actions are not ergonomic and violate some principles of human factor engineering. In particular, since users′ fingers must press the push button 2011′, users can exert the upward force only with difficulty, so that the stopper 20′ often cannot be removed successfully or dangerous situations may occur.

Additionally, executing the above pressing and removing action needs much effort, and thus can be a heavy burden, especially for female operators.

Hence, the inventors of the present invention believe that the shortcomings described above are able to be improved and finally suggest the present invention which is of reasonable design and is an effective improvement based on deep research and thought.

### SUMMARY OF THE INVENTION

A main object of the present invention is to provide a device for removing a stopper of a photoresist bottle by means of which users can remove a stopper mounted on a photoresist bottle with reduced effort and increased efficiency.

To achieve the above-mentioned object, a device for removing a stopper of a photoresist bottle in accordance with the present invention is provided. The device for removing a stopper of a photoresist bottle is used for removing a stopper disposed on a photoresist bottle, wherein the stopper includes a stopper element and at least two push buttons. The device includes: a casing covering the stopper element; and at least two levering units which correspond to the two push buttons and each includes a lever pivotingly disposed on the casing; and a lifting element of which one end is pivotingly disposed on the lever and the other end abuts against a bottom of the stopper element.

The efficacy of the present invention is as follows: based on the design of the levers and the lifting elements of the levering units, the present invention can directly exert a downward force on each lever so that the push buttons are pressed and the stopper element is raised simultaneously via force transformation of the first pivot points and the second points; and further, the length of each lever can be adjusted, so lengthening the arm of exerting force under external condition can enable users to remove the stopper from the photoresist bottle with reduced effort.

To further understand features and technical contents of the present invention, please refer to the following detailed description and drawings related the present invention. However, the drawings are only to be used as references and explanations, not to limit the present invention.

### BRIEF DESCRIPTION OF THE DRAWINGS

FIG. 1 is a schematic view of a conventional stopper disposed on a photoresist bottle;

FIG. 2 is a schematic view of a device for removing a stopper of a photoresist bottle of the present invention;

FIG. 3 is a schematic view showing that the device for removing a stopper of a photoresist bottle of the present invention is wrenched under force;

FIG. 4 is a structural schematic view of a stopper; and

FIG. 5 is a schematic view of the device for removing a stopper of a photoresist bottle of the present invention, in use.

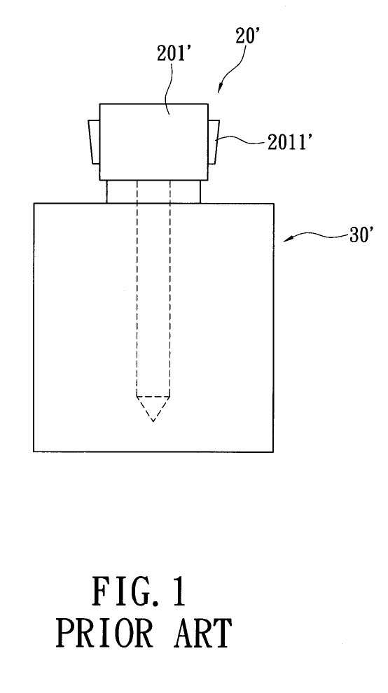

### DETAILED DESCRIPTION OF PREFERRED EMBODIMENTS

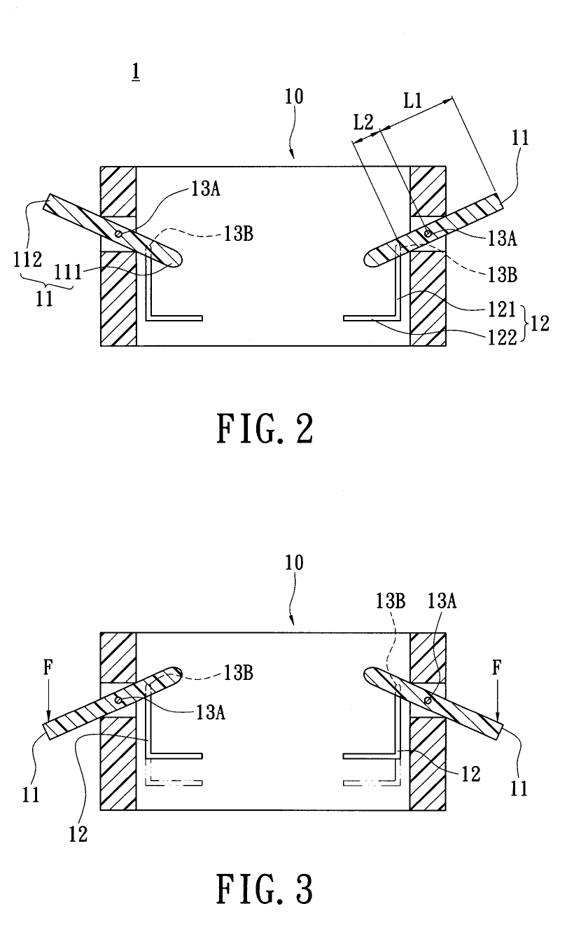

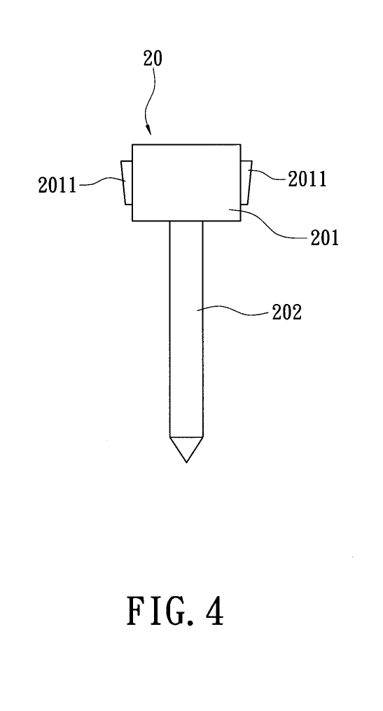

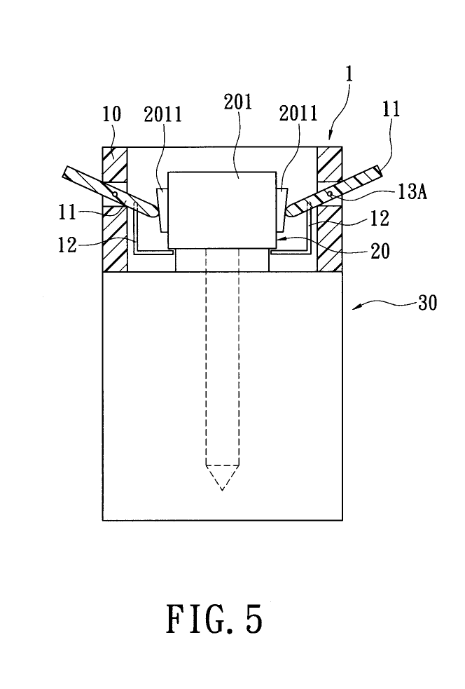

Please refer to FIG. 2, FIG. 4 and FIG. 5 illustrating a device for removing a stopper of a photoresist bottle 1 according to the present invention which is used for removing a stopper 20 disposed on a photoresist bottle 30, wherein the stopper 20 includes a stopper element 201 and at least two push buttons 2011, and the device for removing a stopper of a photoresist bottle 1 can help users to remove the stopper 20 from the photoresist bottle 30 easily and quickly.

Please refer to FIG. 2 and FIG. 3. The device for removing a stopper of a photoresist bottle 1 includes a casing 10 and at least two levering units each of which includes a lever 11 pivotingly disposed on the casing 10 and a lifting element 12 pivotingly disposed on the lever 11.

In the embodiment, the casing 10 has a receiving space. Each lever 11 is pivotingly connected to the casing 10 at a first pivot portion 13A, and the portion extending from the first pivot portion 13A to the tail end 112 of the lever 11 is outside of casing 10 and the other portion, that is the portion extending from the first pivot portion 13A to the front end 111 of the lever 11, is inside casing 10. Furthermore, each lifting element 12 is pivotingly connected to the lever 11 at a second pivot portion 13B which is located between the first pivot portion 13A and the front end 111 of the lever 11, so that the lifting element 12 is also located inside the casing 10.

Each lifting element 12 further includes a first lifting element 121 and a second lifting element 122. One end of the first lifting element 121 is pivotingly connected to the lever 11 at the second pivot portion 13B. The other end (the tail end) of the first lifting element 121 is bent and extended to form the second lifting element 122. In the embodiment, the second lifting element 122 is formed via bending the tail end of the first lifting element 121 by 90 degrees and via extending the tail end, so that the lifting element 12 is ‘L’-shaped.

When a force F is exerted on the exposed portion of each lever 11, the lever 11 rotates around the first pivot portion 13A, and the front end 111 of the lever 11 lifts up, so that the lifting element 12 pivotingly disposed on the lever 11 rises to a higher position with the front end 111 of the lever 11, and at the same time, based on the second pivot portion 13B, the lifting element 12 may keep the verticality of its upward displacement.

Please refer to FIG. 4 and FIG. 5 which are respectively schematic views of stopper 20 to be applied to the photoresist bottle 30 and a schematic view showing how the device for removing a stopper of a photoresist bottle 1 of the present invention is used for removing the stopper 20. Please refer to FIG. 4 firstly, the stopper 20 includes a stopper element 201, push buttons 2011 respectively disposed on two sides of the stopper element 201 and a pipe 202 extending downwards from the stopper element 201.

Please refer to FIG. 5, in the used state, the stopper 20 is mounted in the mouth of the photoresist bottle 30, wherein the stopper element 201 is clamped in the mouth of the photoresist bottle 30 and the pipe 202 is immersed in photoresist in the photoresist bottle 30. When the photoresist in the bottle must be replaced or refilled, users can use the device for removing a stopper of a photoresist bottle 1 of the present invention to remove the stopper 20 from the photoresist bottle 30, thereby improving work efficiency.

At first, the casing 10 of the device for removing a stopper of a photoresist bottle 1 covers the stopper element 201 of the stopper 20 and the second lifting elements 122 of the lifting elements 12 abut against the bottom of stopper element 201. When a user pushes down the levers 11, the front ends 111 of the levers 11 press the corresponding push buttons 2011 and simultaneously raise the lifting elements 12, whereby the stopper element 201 is raised under the action of the second lifting elements 122 so that the stopper 20 is detached from the photoresist bottle 30. In the embodiment, each of the two push buttons 2011 has an inclined plane and the front ends 111 of the levers 11 are preferably rounded. The engagement of the inclined planes with the rounded front ends makes it easier for the levers 11 to press the push buttons 2011.

Additionally, to reduce the force for removing the stopper 20 mounted on the photoresist bottle 30, the present invention proposes a particular design for the levers 11. In the embodiment, the ratio L1:L2 of lever 11, i.e. the ratio between the distance from the tail end 112 of the lever 11 to the first pivot portion 13A and the distance from the first pivot portion 13A to the second pivot portion 13B, is 2:1. The ratio may have a range of 2:1-5:1, and more preferably, 2:1-3:1.

It is noted that the number of the levering units of the device for removing a stopper of a photoresist bottle 1 is not limited to that of the above embodiment, and mainly corresponds to the number of the push buttons 2011 of the stopper element 201 so as to press the push buttons 2011.

Consequently, the present invention has the advantages as follows:

1. The present invention has the effect of reducing effort. Based on the design of the levers and the lifting elements of the levering units, the present invention can directly exert a downward force on each lever so that the push buttons are pressed and the stopper element is raised simultaneously via force transformation of the first pivot points and the second points. Accordingly, users can use the device for removing a stopper of a photoresist bottle of the present invention to remove the stopper from the photoresist bottle easily, thereby improving work efficiency.

2. On the other hand, the present invention can ensure users to remove the stopper efficiently in order to supply and replace photoresist depending on the simple moment and rotating shaft structure.

What are disclosed above are only the specification and the drawings of the preferred embodiment of the present invention and it is therefore not intended that the present invention be limited to the particular embodiments disclosed. It will be understood by those skilled in the art that various equivalent changes may be made depending on the specification and the drawings of the present invention without departing from the scope of the present invention.

What is claimed is:

1. A device for removing a stopper of a photoresist bottle, wherein the stopper includes a stopper element and at least two push buttons, the device comprising:
a casing, covering the stopper element; and
at least two levering units, corresponding to the two push buttons and each levering unit including:
a lever, pivotally disposed on the casing and having a front end and a tail end; and
a lifting element, of which one end is pivotingly disposed on the lever and the other end abuts against a bottom of the stopper element.

2. The device as in claim 1, wherein the lever of each levering unit is pivotingly connected to the casing at a first pivot portion and the lifting element thereof is pivotingly connected to the lever at a second pivot portion which is located between the first pivot portion and the front end of the lever.

3. The device as in claim 2, wherein the ratio between the distance from the tail end of the lever to the first pivot portion and the distance from the first pivot portion to the second pivot portion is 2:1 to 3:1.

4. The device as in claim 3, wherein the lifting element of each levering unit includes a first lifting element and a second lifting element, and the second lifting element is formed via bending and extending one end of the first lifting element.

5. The device as in claim 4, wherein the second lifting element is formed via bending the end of the first lifting element by 90 degrees and via extending the end.

6. The device as in claim 5, wherein the second lifting element abuts against the bottom of the stopper element.

7. The device as in claim 6, wherein the front end of the lever of each levering unit is rounded.

8. The device as in claim 7, wherein the rounded front ends correspond to the push buttons of the stopper.

9. The device as in claim 8, wherein each push button has an inclined plane, and the rounded front ends correspond to the inclined planes.

10. The device as in claim 9, wherein the tail end of the lever of each levering unit is located outside the casing, and the front end of the lever and the lifting element of each levering unit are located inside the casing.
